(19) United States
(12) Patent Application Publication
(10) Pub. No.: US 2025/0219171 A1
(43) Pub. Date: Jul. 3, 2025

(54) DETECTION AND MITIGATION OF ANOMALOUS CONDITIONS IN BATTERY MODULES USING THIN-FILM PRESSURE SENSORS

(71) Applicant: GM GLOBAL TECHNOLOGY OPERATIONS LLC, DETROIT, MI (US)

(72) Inventors: Jingyuan Liu, Shanghai (CN); Dewen Kong, Shanghai (CN); Si Chen, Shanghai (CN); Yuan Li, Shanghai (CN); Haijing Liu, Shanghai (CN)

(21) Appl. No.: 18/405,294

(22) Filed: Jan. 5, 2024

(30) Foreign Application Priority Data
Dec. 27, 2023 (CN) 202311826549.1

(51) Int. Cl. H01M 10/48; B60L 50/60; B60L 58/10; B60R 16/033; G01K 1/14; G01L 5/00; H01M 10/42; H01M 50/211

(52) U.S. Cl. CPC H01M 10/482; G01K 1/14; G01L 5/00; H01M 10/425; H01M 10/486; H01M 50/211; B60L 50/60; B60L 58/10; B60R 16/033; H01M 2010/4271; H01M 2220/20

(57) ABSTRACT

Some embodiments disclosed herein are directed to battery management systems utilizing thin-film pressure sensors to determine anomalous conditions associated with battery modules. Some embodiments may include receiving a pressure measurement from the thin-film pressure sensor disposed between two battery cells in a battery module, and determining, based on the pressure measurement from the thin-film pressure sensor, an abnormal condition associated with the battery module. Other embodiments may be disclosed or claimed.

### CROSS-REFERENCE TO RELATED APPLICATIONS

This application claims the benefit of Chinese Patent Application No. 202311826549.1, filed Dec. 27, 2023, the disclosure of which is incorporated herein by reference in its entirety.

### INTRODUCTION

The present disclosure relates to detecting and mitigating anomalous conditions associated with battery modules. In particular, embodiments of the present disclosure relate to battery management systems utilizing thin-film pressure sensors to determine anomalous conditions associated with battery modules.

Increasingly, vehicles are produced with propulsion systems utilizing an electric motor powered by a lithium-based battery system, such as lithium ion batteries (LIBs) and lithium metal batteries (LMBs). Such battery systems may include multiple battery modules that are pressurized.

After LIB/LMB battery modules are loaded on a battery electric vehicle (BEV), there are few conventional options to monitor the health of the battery modules. For example, conventional systems typically monitor the voltage and temperature of a battery module, but these measurements often reflect only a partial view of battery cell health. Embodiments of the present disclosure provide improved systems to detect and mitigate anomalous conditions in battery modules, and can provide timely warnings when a battery cell is displaying an anomalous status or reaching its end of life.

### SUMMARY

In one exemplary embodiment, a system is provided with a battery module that includes a first battery cell, a second battery cell, and a thin-film pressure sensor disposed between the first battery cell and the second battery cell. The thin-film pressure sensor is adapted to measure a change in pressure associated with at least one of: a swelling of the first battery cell, and a swelling of the second battery cell. The system further includes a battery management system that includes a processor and memory coupled to the processor and storing instructions that, when executed by the processor, cause the battery management system to receive a pressure measurement from the thin-film pressure sensor and determine, based on the pressure measurement from the thin-film pressure sensor, an abnormal condition associated with the battery module. The memory further stores instructions to cause the battery management system to generate an alert that includes an indication of the abnormal condition.

In addition to one or more of the features described herein, the first battery cell and the second battery cell are lithium-based battery cells.

In addition to one or more of the features described herein, the thin-film pressure sensor is a first thin-film pressure sensor, and wherein the battery module further includes a module frame, a third battery cell, and a second thin-film pressure sensor disposed between the third battery cell and the module frame.

In addition to one or more of the features described herein, the battery module comprises a plurality of battery cells that include the first battery cell, the second battery cell, and the third battery cell, and wherein at least two battery cells are disposed between the first thin-film pressure sensor and the second thin-film pressure sensor.

In addition to one or more of the features described herein, the system further comprises a temperature sensor coupled to a battery cell from the plurality of battery cells, wherein the temperature sensor is not coupled to the first battery cell, the second battery cell, or the third battery cell.

In addition to one or more of the features described herein, determining the abnormal condition associated with the battery module includes determining that a change in pressure measured by the thin-film pressure sensor within a predetermined time period exceeds a predetermined maximum pressure level.

In addition to one or more of the features described herein, determining the abnormal condition associated with the battery module includes determining that an average pressure, measured by the thin-film pressure sensor over a predetermined time period when the battery module is in a predetermined state, exceeds a predetermined threshold.

In another exemplary embodiment, a vehicle is provided with a battery module that includes a first battery cell, a second battery cell, and a thin-film pressure sensor disposed between the first battery cell and the second battery cell. The thin-film pressure sensor is adapted to measure a change in pressure associated with at least one of: a swelling of the first battery cell, and a swelling of the second battery cell. The vehicle further includes a battery management system that includes a processor and memory coupled to the processor and storing instructions that, when executed by the processor, cause the battery management system to receive a pressure measurement from the thin-film pressure sensor, and determine, based on the pressure measurement from the thin-film pressure sensor, an abnormal condition associated with the battery module. The memory further stores instructions to cause the battery management system to generate an alert that includes an indication of the abnormal condition.

In addition to one or more of the features described herein, the first battery cell and the second battery cell are lithium-based battery cells.

In addition to one or more of the features described herein, the thin-film pressure sensor is a first thin-film pressure sensor, and wherein the battery module further comprises a module frame, a third battery cell, and a second thin-film pressure sensor disposed between the third battery cell and the module frame.

In addition to one or more of the features described herein, the battery module comprises a plurality of battery cells that include the first battery cell, the second battery cell, and the third battery cell, and wherein at least two battery cells are disposed between the first thin-film pressure sensor and the second thin-film pressure sensor.

In addition to one or more of the features described herein, a temperature sensor is coupled to a battery cell from the plurality of battery cells, wherein the temperature sensor is not coupled to the first battery cell, the second battery cell, or the third battery cell.

In addition to one or more of the features described herein, determining the abnormal condition associated with the battery module includes determining that a change in pressure measured by the thin-film pressure sensor within a predetermined time period exceeds a predetermined maximum pressure level.

In addition to one or more of the features described herein, determining the abnormal condition associated with the battery module includes determining that an average pressure, measured by the thin-film pressure sensor over a predetermined time period when the battery module is in a predetermined state, exceeds a predetermined threshold.

In another exemplary embodiment, a battery module includes a first battery cell, a second battery cell, and a thin-film pressure sensor disposed between the first battery cell and the second battery cell. The thin-film pressure sensor is adapted to measure a change in pressure associated with at least one of: a swelling of the first battery cell, and a swelling of the second battery cell.

In addition to one or more of the features described herein, the first battery cell and the second battery cell are lithium-based battery cells.

In addition to one or more of the features described herein, the thin-film pressure sensor is a first thin-film pressure sensor, and wherein the battery module further comprises a module frame, a third battery cell, and a second thin-film pressure sensor disposed between the third battery cell and the module frame.

In addition to one or more of the features described herein, the battery module comprises a plurality of battery cells that include the first battery cell, the second battery cell, and the third battery cell, and wherein at least two battery cells are disposed between the first thin-film pressure sensor and the second thin-film pressure sensor.

In addition to one or more of the features described herein, a temperature sensor is coupled to a battery cell from the plurality of battery cells.

In addition to one or more of the features described herein, the temperature sensor is not coupled to the first battery cell, the second battery cell, or the third battery cell.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram of a vehicle for use in conjunction with one or more embodiments of the present disclosure;

FIG. 2 is a functional block diagram illustrating aspects of a battery management system in accordance with embodiments of the present disclosure;

FIG. 3A is a perspective cutaway view of a battery module in accordance with various embodiments of the present disclosure;

FIG. 3B is a side-view of thin-film pressure sensor 315 in accordance with various embodiments;

FIG. 3C illustrates a graphical example of different pressure levels measured by different portions of a thin-film pressure sensor in accordance with various embodiments;

FIG. 4A is a side view of a battery module in accordance with various embodiments;

FIG. 4B is a side view of the battery module in FIG. 4A illustrating an abnormal condition associated with the battery module in accordance with various embodiments;

FIG. 4C is a side view of the battery module in FIG. 4A illustrating another abnormal condition associated with the battery module in accordance with various embodiments;

FIG. 4D is a side view of the battery module in FIG. 4A illustrating yet another abnormal condition associated with the battery module in accordance with various embodiments; and

FIG. 5 is a flow diagram illustrating a process in accordance with various aspects of the present disclosure.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, a battery management system for an electric motor is provided. The battery management system may determine an abnormal condition associated with a battery module based on a pressure measurement from a thin-film pressure sensor within the battery module adapted to measure pressure variations due to swelling and other deformation of the cells of the battery module. In this manner, embodiments of the present disclosure can quickly and accurately determine abnormal battery conditions.

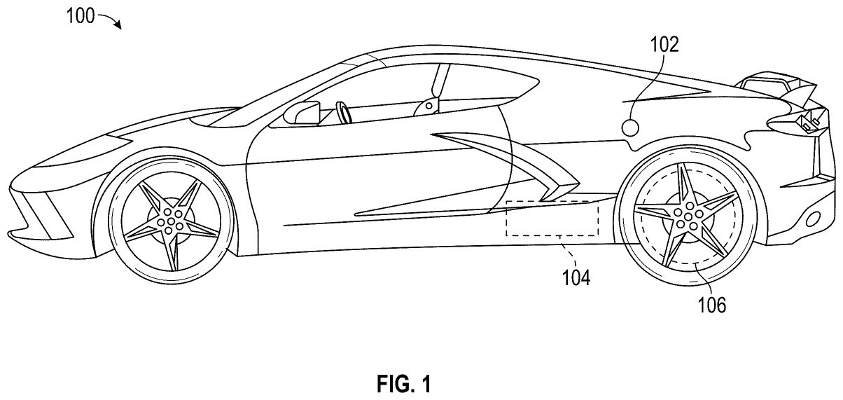

Referring now to FIG. 1, a schematic diagram of a vehicle 100 for use in conjunction with one or more embodiments of the present disclosure is shown. The vehicle 100 includes a charging port 102, a battery 104, and an electric motor 106. In one embodiment, the vehicle 100 is a hybrid vehicle that utilizes both an internal combustion engine and an electric motor. In another embodiment, the vehicle 100 is an electric vehicle that only utilizes electric motors. In exemplary embodiments, the vehicle 100 is configured to be connected, via charging port 102, to a high-voltage power source (i.e., a voltage source of at least 200 volts (V)), which is used to charge the battery 104. The electric motor 106 is configured to receive power from the battery 104 to provide propulsion for the vehicle 100.

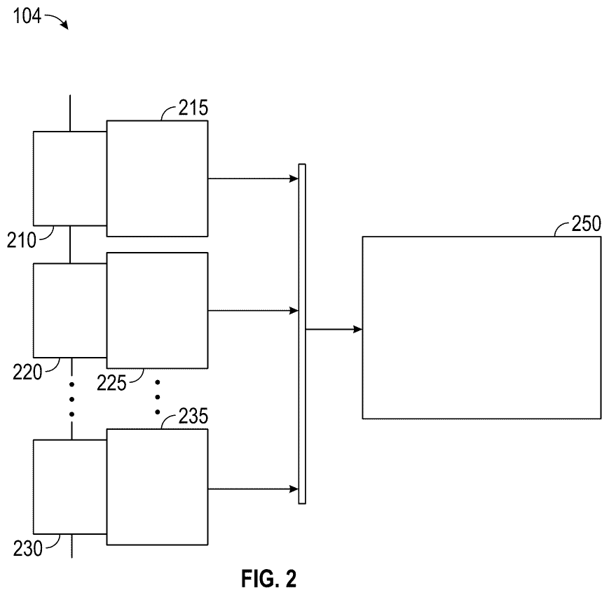

FIG. 2 is an example of a functional block diagram illustrating aspects of a battery management system in accordance with embodiments of the present disclosure. In this example, battery 104 comprises a plurality of lithium-based battery modules 210, 220, 230. Each respective battery module is coupled to respective battery monitoring unit 215, 225, 235. The battery monitoring units 215, 225, 235 are coupled to a battery management system (BMS) 250.

In the example depicted in FIG. 2, three battery modules are shown as an example, but a practical system may include any suitable number of battery modules. In some embodiments a single battery monitoring unit may be coupled to a plurality of battery modules. Additionally or alternatively, the BMS 250 may couple directly to some or all of the battery modules 210, 220, 230 to perform the functionality of the battery monitoring units 215, 225, 235.

In some exemplary embodiments, the BMS 250 includes at least one processor, such as a general processor, a central processing unit, an application-specific integrated circuit (ASIC), a digital signal processor, a field-programmable gate array (FPGA), a digital circuit, an analog circuit, or combinations thereof. In some embodiments, the BMS 250 includes a memory in communication with the processor to store data and instructions executable by the processor to retrieve measurements from the battery 104 and control features of the battery 104.

For example, in some embodiments the BMS 250 manages charging of the vehicle's battery 104 (a lithium-ion battery in this example) and monitors and controls the battery 104 as it discharges during operation of the vehicle 100. The BMS receives measurement signals from the battery modules 210, 220, 230 (via battery monitoring units 215, 225, 235 in this example) from sensors coupled to the battery modules. The measurement signals may include pressure measurements from one or more thin-film pressure sensors within the battery modules, as well as temperature measurements from one or more temperature sensors. The BMS 250 may receive measurements from other types of sensors regarding characteristics of the battery modules as well.

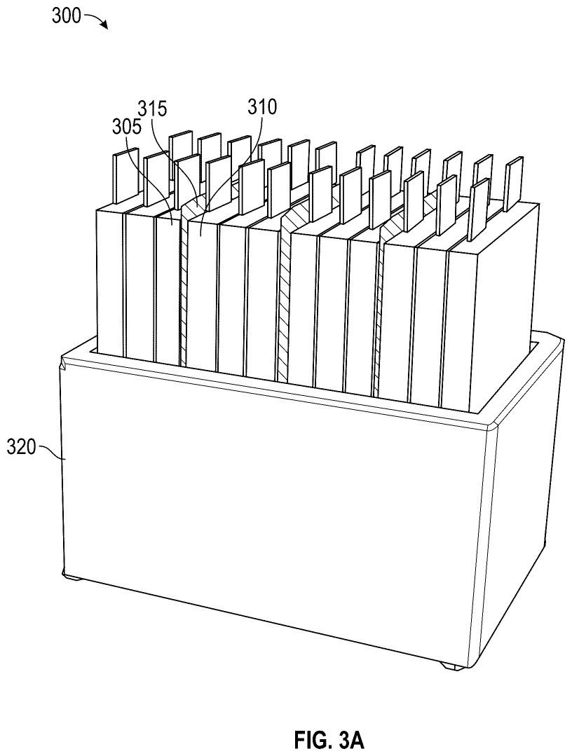

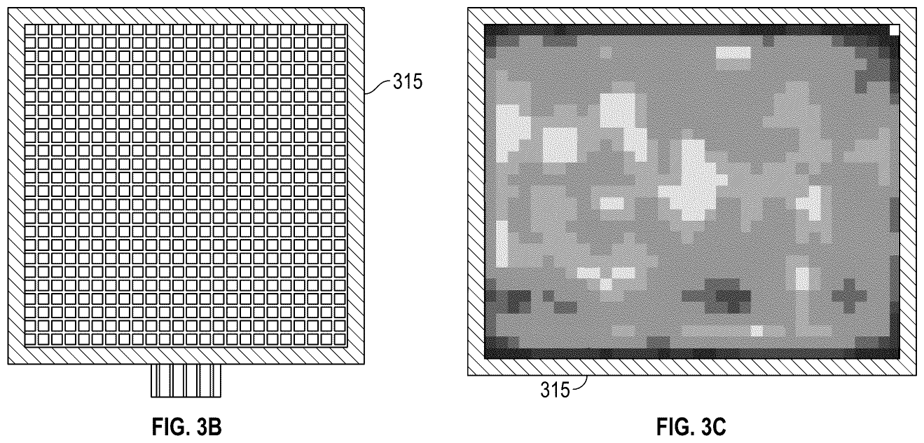

FIG. 3A is a perspective cutaway view of a battery module in accordance with various embodiments of the present disclosure. In this example, battery module 300 includes a plurality of battery cells, which include a first battery cell 305 and a second battery cell 310. The battery cells are enclosed by a module frame 320. A thin-film pressure sensor 315 is disposed between the first battery cell 305 and the second battery cell 310. A battery module of embodiments of the present disclosure may include any suitable number of battery cells and thin-film pressure sensors. In the example depicted in FIG. 3A, for instance, battery module 300 includes a total of twelve battery cells, with three thin-film pressure sensors. In this example, a thin-film pressure sensor is disposed between every three cells.

FIG. 3B is a side-view of thin-film pressure sensor 315 in accordance with various embodiments. In this example, thin-film pressure sensor 315 is rectangular to correspond to the rectangular sides of battery cells 305, 310, though thin-film pressure sensors operating in conjunction with alternate embodiments of the present disclosure may be any suitable size, shape, and configuration to measure pressure changes associated with the cells (e.g., from swelling). FIG. 3C illustrates a graphical example of different pressure levels (denoted using different shadings) measured by different portions of the thin-film pressure sensor 315. In this manner, the thin-film pressure sensor 315 can measure the level of pressure exerted by the cells of a battery module from different portions of the cells. Among other things, identifying the specific portion(s) of a battery cell that are swelling or otherwise deforming can help battery management systems of the present disclosure identify the nature and severity of anomalous conditions associated with a battery module.

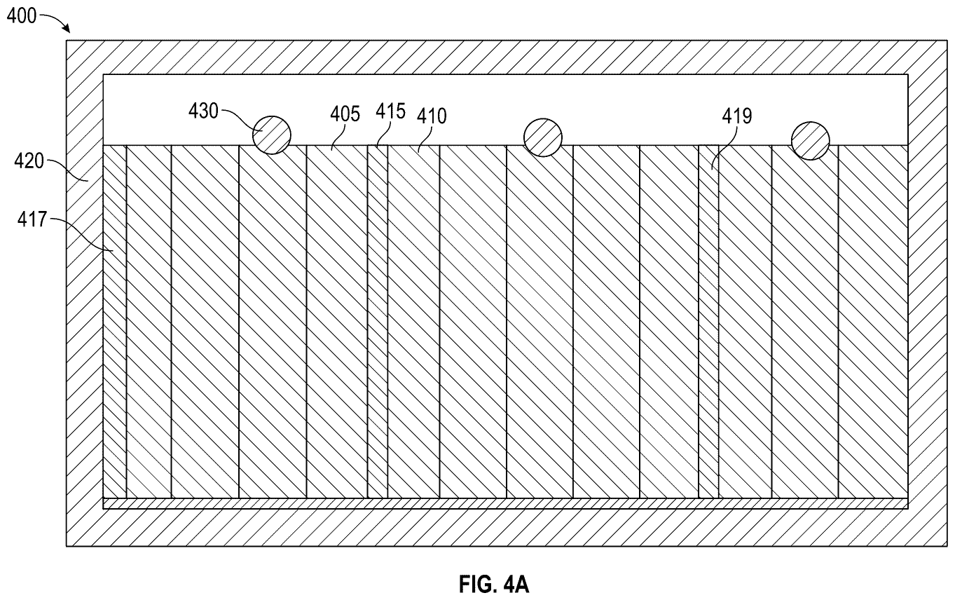

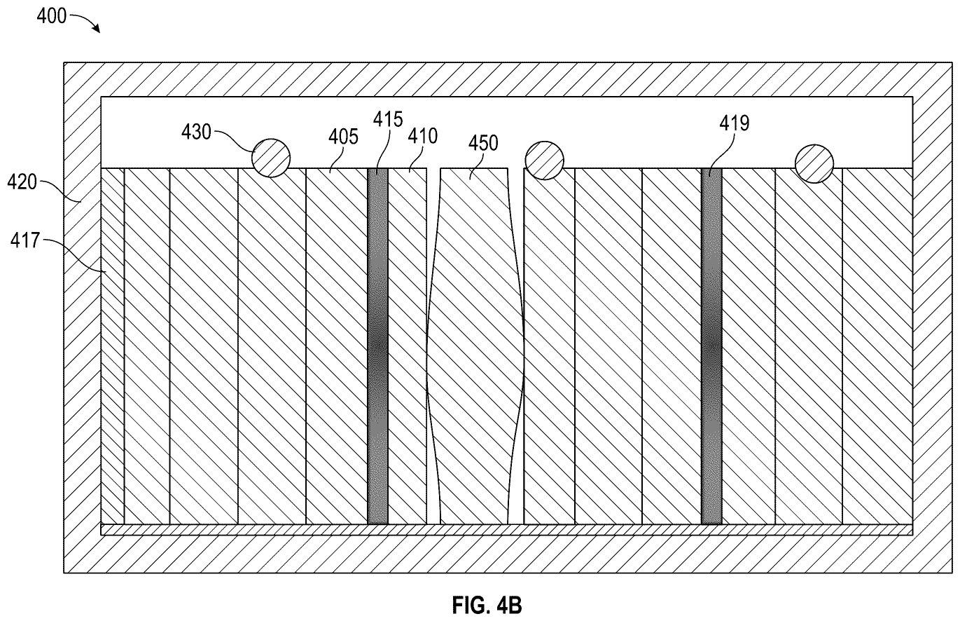

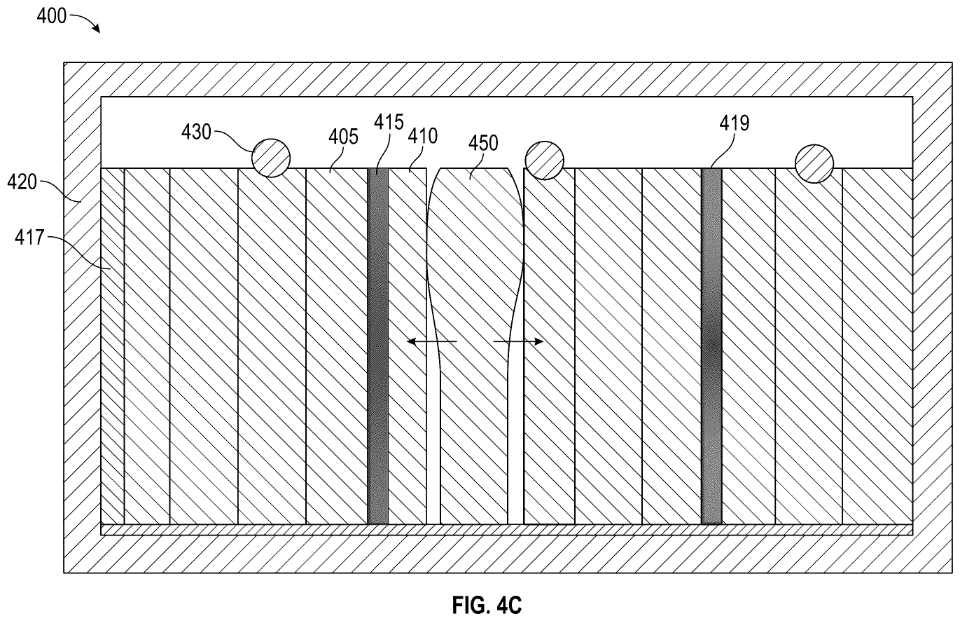

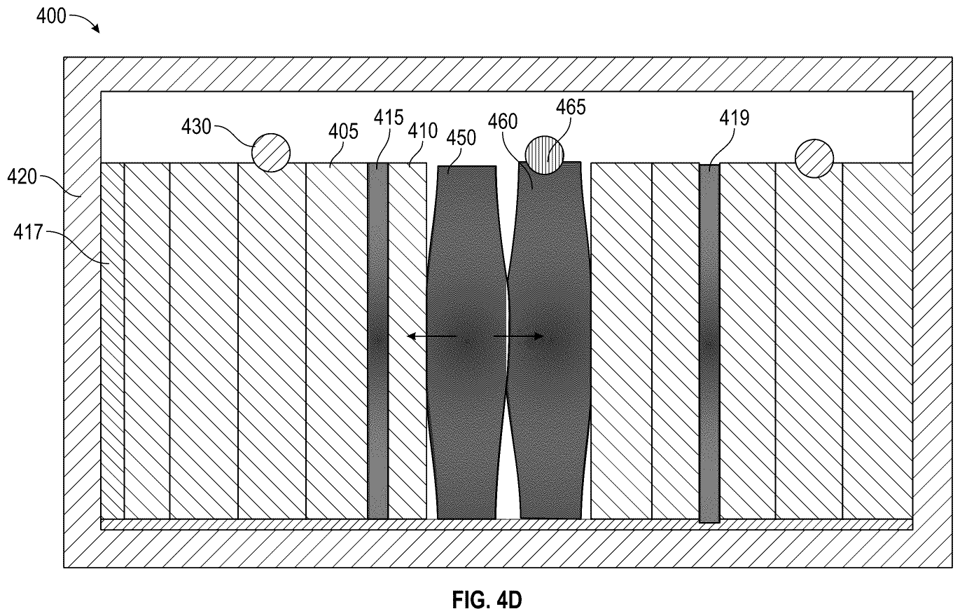

FIG. 4A is a side sectional view of a battery module in accordance with various embodiments. In this example, battery module 400 includes a plurality of battery cells housed within a module frame 420, including a first battery cell 405 and a second battery cell 410. The battery module 400 further includes three temperature sensors, such as temperature sensor 430. The battery module 400 further includes three thin-film pressure sensors 415, 417, and 419. Thin-film pressure sensor 415 is disposed between the first battery cell 405 and the second battery cell 410. In this example, the plurality of battery cells are Lithium-based battery cells, though embodiments of the present disclosure may operate in conjunction with other types of battery cells. As shown, thin-film pressure sensors 415 and 419 are disposed between, and in contact with, their respective neighboring cells. Thin-film pressure sensor 417 is disposed between the module frame 420 and the left-most cell from the plurality of cells.

In the example depicted in FIG. 4A, twelve battery cells, three thin-film pressure sensors, and three temperature sensors. However, alternate embodiments may include more or fewer of each of these components. For example, in some embodiments a battery module may include four or more thin-film pressure sensors, such as two sensors between a cell and the module frame of the battery module (as with sensor 417) and two or more sensors interspaced among the cells of the battery module. In this manner, the BMS 250 is better able to adjust for pressure changes associated with movement of a vehicle housing the battery modules, such as when the vehicle accelerates, stops, or turns.

Embodiments of the present disclosure may also operate in conjunction with different types of battery cells, such as prismatic cells and pouch cells. For example, with respect to prismatic cells, a thin-film sensor may be sized and configured to be placed in contact with a prismatic cell such that the thin-film sensor is smaller than the cross-section of the cell with which it is in contact. Among other things, this helps ensure the thin-film sensor can detect any swelling or other deformities of the prismatic cell, while also avoiding contact with the rigid lid of the cell (which is less likely to deform than the body of the cell) and avoiding conflicts with the welding of tabs extending from the cell.

With respect to pouch cells, the thin-film sensor may likewise be sized and configured to be placed in contact with a pouch cell such that the thin-film sensor is smaller than the cross-section of the cell with which it is in contact. Among other things, this helps avoid sealing non-flat tap parts associated with the pouch cell, which could degrade pressure measurements collected by the thin-film sensor.

As illustrated in FIG. 4A, the thin-film pressure sensors 415, 417, and 419 are arranged alternatively with the three temperature sensors (such as temperature sensor 430). As discussed below, this may help the BMS 250 use data from the different sensors to identify specific cells of a battery module exhibiting abnormalities. In some embodiments, the BMS may receive data from thin-film pressure sensors, temperature sensors, and other sensors (such as a voltage sensor) via a sampling chip coupled to the battery module. In some embodiments, the sampling chip may be coupled to, or be integrated into, a battery monitoring unit (such as battery monitoring units 215, 225, 235 in FIG. 2).

FIG. 4B is a side sectional view of the battery module in FIG. 4A illustrating an abnormal condition associated with the battery module in accordance with various embodiments. In this example, battery cell 450 begins to swell, exerting outward pressure on its neighboring cells. As the swelling of battery cell 450 exerts pressure on its neighboring cells, the change in pressure can be measured by thin-film pressure sensor 415 and thin-film pressure sensor 419. In particular, the BMS 250 may identify a relatively larger pressure measured by sensor 415 (with only one intervening cell between sensor 415 and cell 450) compared to the pressure measured by sensor 419, with three intervening cells between sensor 419 and cell 450. The BMS 250 may accordingly identify cell 450 as the source of the abnormal swelling condition based on the positions of sensors 415 and 419 and their relative pressure readings.

Additionally, the BMS may determine the nature of the deformation of cell 450. In this example, the swelling occurs in the middle of cell 450, thereby applying a relatively higher level of pressure to the middle portions of thin-film pressure sensors 415, 419 and lower levels of pressure to the outer portions of the sensors 415, 419. In this example, the BMS 250 may determine that the likely cause of the swelling in cell 450 is due to a build-up of gasses resulting from a failure in the cell 450.

FIG. 4C is a side sectional view of the battery module in FIG. 4A illustrating another abnormal condition associated with the battery module in accordance with various embodiments. In this example, cell 450 is swelling at its top end, exerting pressure outward (as indicated by the arrows) similar to the example in FIG. 4B. In this example, the swelling occurs at the top end of cell 450, thereby applying a relatively higher level of pressure to the top portions of thin-film pressure sensors 415, 419 and lower levels of pressure to the middle and bottom portions of the sensors 415, 419. The BMS 250 may thus determine that the swelling of cell 450 in this example is likely due to a Lithium-plating failure in the battery rather than gas generation as in FIG. 4B.

FIG. 4D is a side view of the battery module in FIG. 4A illustrating yet another abnormal condition associated with the battery module in accordance with various embodiments. In this example, neighboring cells 450 and 460 are both swelling, exerting outward pressure on each other and their neighboring cells. In this example, temperature sensor 465 is coupled, or located proximate, to cell 460, and measures an increase in temperature associated with cell 460 as thin-film pressure sensors 415, 419 detect an increase in pressure from the swelling of cells 450 and 460. In this example, the BMS 250 may use the measurements from the temperature sensor 465 in conjunction with the pressure measurements from thin-film pressure sensors 415, 419 to identify cell 450 and 460 both exhibiting abnormal conditions.

In systems relying on thermal sensors alone to monitor battery modules, a failing battery cell often exhibits significant swelling before an associated temperature increase can be detected-thereby delaying detection of abnormal conditions associated with the battery cell. Embodiments of the present disclosure, by contrast, can detect pressure increases due to swelling or other deformations of a battery cell before subsequent temperature increases can be measured, but can also utilize temperature sensor data (in conjunction with the pressure sensor data) to help identify the specific battery cell(s) exhibiting abnormalities.

In some embodiments, the BMS 250 may be adapted to detect and mitigate anomalous battery module conditions based on relatively short-term changes in pressure measurements from one or more thin-film pressure sensors in a battery module. For example, in some embodiments, the BMS 250 may detect an abnormal condition associated with a battery module within a predetermined time period (e.g., 1 min or 30 secs) when at a pressure level or change in pressure for at least one thin-film pressure sensor in the battery module exceeds a predetermined threshold.

Such short-term readings may further be periodically examined by the BMS 250 to identify a gradual abnormal condition developing with the battery module, such as the failure of one or more cells. For example, the BMS 250 may analyze a pressure level or change in pressure from the same thin-film pressure sensor that measured a level that exceeded the predetermined threshold noted above. Such periodic measurements may occur at any suitable interval, such as one second, ten seconds, thirty seconds, etc. If the second measurement is not greater than the first measurement, the BMS 250 may continue monitoring the sensor or take no further action. However, if the second measurement is greater than the first measurement, the BMS 250 may determine there is a substantial likelihood of an abnormal condition developing with the battery (such as a risk of thermal runaway), and generate an alert to the driver of the vehicle (e.g., through a user interface of the vehicle) as well as to other computing devices in communication with the BMS 250.

In some embodiments, the BMS 250 may determine whether the pressure measurements from a plurality of thin-film pressure sensors in a battery module indicate a gradient from one side of the battery module to the other. In such cases, the BMS 250 may continue monitoring the pressure measurements until a predetermined condition is met, such as when the most recent pressure level or pressure change is less than a baseline measurement. Alternatively, if the most recent pressure level or pressure change is increasing, the BMS 250 may generate the alert. The BMS 250 may also determine whether to generate the alert based on other measurements associated with a battery module, such as a voltage drop reported in tracking duration, or a change in pressure that increases for at least a predetermined time period (e.g., 5 minutes).

In some embodiments, the BMS 250 may analyze voltage, temperature, and pressure sensor measurements concurrently to determine and mitigate abnormal conditions associated with a battery module. For example, the BMS 250 may generate an alert or take other mitigation actions in response to one or more of: a sudden voltage drop, a pressure reading beyond a predetermined threshold, or a temperature reading beyond a predetermined threshold.

The BMS 250 may scale a mitigation response based on a determined severity of a battery abnormality. For example, if a temperature reading is high but not excessive (e.g., 90 deg C.) and pressure readings are not anomalous, the BMS 250 may reduce vehicle power and enhance cooling power to help mitigate battery abnormality and prevent thermal runaway. In another example, if the BMS 250 identifies a voltage level beyond a predetermined threshold, in conjunction with an excessive pressure reading, the BMS 250 may generate an alert that instructs the user to park the vehicle and repair/replace the battery module to mitigate a cell that is likely overcharged and gassing inside.

In some embodiments, the BMS 250 may generate the alert or take other mitigation actions based on the relative location(s) of pressure measured by a thin-film pressure sensor in a battery module. For example, as discussed with reference to FIG. 4B and FIG. 4D above, an increase in pressure with a relatively high center gradient may be indicative of a cell swelling due to gasses building up within the cell. In such cases the BMS 250 may generate the alert and take other mitigation actions immediately without needing to analyze data from other sensors or sources.

In some embodiments, the BMS 250 may track longer-term changes in pressure measurements generated by the thin-film pressure sensor(s) in a battery module. For example, in some embodiments the BMS 250 may track conditions indicative of a battery cell or module approaching its end of life. In some embodiments for example, a battery cell may swell relatively uniformly (as illustrated in FIG. 4B and FIG. 4D), therefore the BMS 250 may track the average pressure levels across the thin-film sensor over time. If a measured pressure value meets or exceeds a predetermined threshold, the BMS 250 may determine that the cell has exceeded a safe level of swelling and generates an alert to the vehicle control system or other computer system in communication with the BMS 250 indicating that the battery module associated with the swelling cell needs appropriate repair or replacement.

In some embodiments, such as to avoid battery cell abnormalities associated with Lithium plating (such as illustrated in FIG. 4C), the BMS 250 may analyze pressure measurements from the thin-film pressure sensors of a battery module indicative of non-uniform swelling in the cell, as illustrated by the top end of the cell 450 swelling in FIG. 4C. In such cases, the BMS 250 may track pressure variations across a thin-film sensor array. The BMS 250 may use any suitable index for the tracking, such as a standard derivation or square derivation. In this manner, the BMS 250 can detect that the measured pressure is indicative of one portion of the cell swelling greater than other portions of the cell in accordance with an abnormality due to Lithium plating. In such cases, the BMS 250 may generate an alert associated with probably Lithium plating in the cell, and take mitigation measures such as blocking fast charging of the battery module containing the cell to avoid exacerbating the Lithium plating.

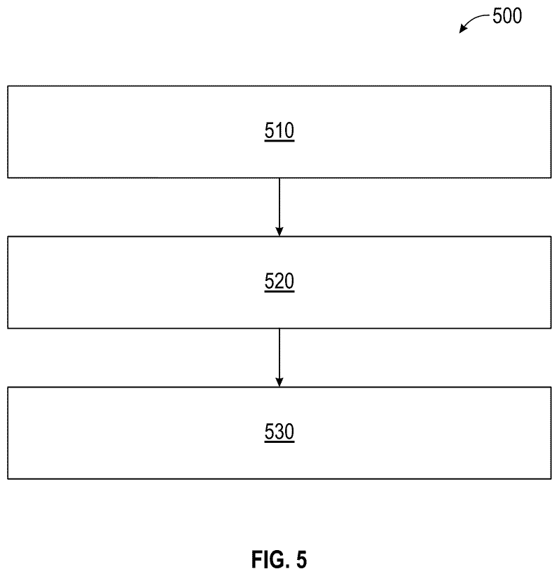

FIG. 5 illustrates an example of a process that may be performed in accordance with various embodiments. The process 500 in FIG. 5 may be performed by any suitable device or combination of devices, such as by a processor of battery management system 250 executing computer-readable instructions stored in a memory of the battery management system 250.

In this example, process 500 includes, at 510, receiving a pressure measurement from a thin-film pressure sensor within a battery module. The system may receive pressure measurements from any suitable number of thin-film pressure sensors, which may be disposed between the cells of the battery module as well as between a cell and the housing of the battery module.

The process 500 further includes, at 520, determining, based on the pressure measurement from the thin-film pressure sensor, an abnormal condition associated with the battery module. The abnormal condition may be determined in conjunction with data from other sensors (such as temperature and voltage sensors) as described above. The system may also determine a specific cell associated with the abnormality as well as a type of abnormality based on the relative pressures measured by different portions of a thin-film pressure sensor.

The process 500 further includes, at 530, generating an alert that includes an indication of the abnormal condition. The alert may be transmitted to any suitable computing device, such as the control system of the vehicle carrying the battery module, a mobile computing device of the user, or other systems.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system, comprising:
a battery module that includes:
a first battery cell;
a second battery cell; and
a thin-film pressure sensor disposed between the first battery cell and the second battery cell, the thin-film pressure sensor adapted to measure a change in pressure associated with at least one of: a swelling of the first battery cell, and a swelling of the second battery cell; and
a battery management system that includes:
a processor; and
memory coupled to the processor and storing instructions that, when executed by the processor, cause the battery management system to:
receive a pressure measurement from the thin-film pressure sensor;
determine, based on the pressure measurement from the thin-film pressure sensor, an abnormal condition associated with the battery module; and
generate an alert that includes an indication of the abnormal condition.

2. The system of claim 1, wherein the first battery cell and the second battery cell are lithium-based battery cells.

3. The system of claim 1, wherein the thin-film pressure sensor is a first thin-film pressure sensor, and wherein the battery module further comprises:
a module frame;
a third battery cell; and
a second thin-film pressure sensor disposed between the third battery cell and the module frame.

4. The system of claim 3, wherein the battery module comprises a plurality of battery cells that include the first battery cell, the second battery cell, and the third battery cell, and wherein at least two battery cells are disposed between the first thin-film pressure sensor and the second thin-film pressure sensor.

5. The system of claim 4, further comprising a temperature sensor coupled to a battery cell from the plurality of battery cells, wherein the temperature sensor is not coupled to the first battery cell, the second battery cell, or the third battery cell.

6. The system of claim 1, wherein determining the abnormal condition associated with the battery module includes determining that a change in pressure measured by the thin-film pressure sensor within a predetermined time period exceeds a predetermined maximum pressure level.

7. The system of claim 1, wherein determining the abnormal condition associated with the battery module includes determining that an average pressure, measured by the thin-film pressure sensor over a predetermined time period when the battery module is in a predetermined state, exceeds a predetermined threshold.

8. A vehicle comprising:
a battery module that includes:
a first battery cell;
a second battery cell; and
a thin-film pressure sensor disposed between the first battery cell and the second battery cell, the thin-film pressure sensor adapted to measure a change in pressure associated with at least one of: a swelling of the first battery cell, and a swelling of the second battery cell; and
a battery management system that includes:
a processor; and
memory coupled to the processor and storing instructions that, when executed by the processor, cause the battery management system to:
receive a pressure measurement from the thin-film pressure sensor;
determine, based on the pressure measurement from the thin-film pressure sensor, an abnormal condition associated with the battery module; and
generate an alert that includes an indication of the abnormal condition.

9. The vehicle of claim 8, wherein the first battery cell and the second battery cell are lithium-based battery cells.

10. The vehicle of claim 8, wherein the thin-film pressure sensor is a first thin-film pressure sensor, and wherein the battery module further comprises:
a module frame;
a third battery cell; and
a second thin-film pressure sensor disposed between the third battery cell and the module frame.

11. The vehicle of claim 10, wherein the battery module comprises a plurality of battery cells that include the first battery cell, the second battery cell, and the third battery cell, and wherein at least two battery cells are disposed between the first thin-film pressure sensor and the second thin-film pressure sensor.

12. The vehicle of claim 11, further comprising a temperature sensor coupled to a battery cell from the plurality of battery cells, wherein the temperature sensor is not coupled to the first battery cell, the second battery cell, or the third battery cell.

13. The vehicle of claim 8, wherein determining the abnormal condition associated with the battery module includes determining that a change in pressure measured by the thin-film pressure sensor within a predetermined time period exceeds a predetermined maximum pressure level.

14. The vehicle of claim 8, wherein determining the abnormal condition associated with the battery module includes determining that an average pressure, measured by the thin-film pressure sensor over a predetermined time period when the battery module is in a predetermined state, exceeds a predetermined threshold.

15. A battery module, comprising:
a first battery cell;
a second battery cell; and
a thin-film pressure sensor disposed between the first battery cell and the second battery cell, the thin-film pressure sensor adapted to measure a change in pressure associated with at least one of: a swelling of the first battery cell, and a swelling of the second battery cell.

16. The battery module of claim 15, wherein the first battery cell and the second battery cell are lithium-based battery cells.

17. The battery module of claim 15, wherein the thin-film pressure sensor is a first thin-film pressure sensor, and wherein the battery module further comprises:
a module frame;
a third battery cell; and
a second thin-film pressure sensor disposed between the third battery cell and the module frame.

18. The battery module of claim 17, wherein the battery module comprises a plurality of battery cells that include the first battery cell, the second battery cell, and the third battery cell, and wherein at least two battery cells are disposed between the first thin-film pressure sensor and the second thin-film pressure sensor.

19. The battery module of claim 15, further comprising a temperature sensor coupled to a battery cell from the plurality of battery cells.

20. The battery module of claim 19, wherein the temperature sensor is not coupled to the first battery cell, the second battery cell, or the third battery cell.
